(19) United States
(12) Patent Application Publication
(10) Pub. No.: US 2012/0089257 A1
(43) Pub. Date: Apr. 12, 2012

(54) Method And Device For Controlling The Temperature Of A Building

(75) Inventor: Simon Holger, St. Johann (DE)

(73) Assignee: BAM DEUTSCHLAND AG, Stuttgart (DE)

(21) Appl. No.: 13/376,452

(22) PCT Filed: Jul. 1, 2010
(86) PCT No.: PCT/EP2010/003940

§ 371 Date: Dec. 6, 2011

(30) Foreign Application Priority Data
Jul. 3, 2009 (DE) 10 2009 032 208.6

(51) Int. Cl. G05D 23/19

(52) U.S. Cl. 700/278

(57) ABSTRACT

A method is disclosed for controlling the temperature of a building having at least one cooling/heating system, which is integrated in a ceiling of the building and through which a liquid flows, in which method an ambient air temperature of the building is measured and a target value for a feed temperature of the liquid is generated according to the measured ambient air temperature. In at least one example embodiment of the method, a fictitious ambient air temperature predicted for a future point in time is used to generate the target value of the feed temperature, a base value of the predicted ambient air temperature being determined as a function value of a function that maps points in time within a day to predetermined temperature values, a radiation temperature of the sky above the building being measured and a degree of cloudiness being determined according to the measured radiation temperature, a correction value being generated according to the determined degree of cloudiness, the base value being combined with the correction value, and the fictitious ambient air temperature predicted for the future point in time being generated as a function of the combination.

### PRIORITY STATEMENT

This application is the national phase under 35 U.S.C. §371 of PCT International Application No. PCT/EP2010/003940 which has an International filing date of Jul. 1, 2010, which designated the United States of America, and which claims priority to German patent application number DE 10 2009 032 208.6 filed Jul. 3, 2009, the entire contents of each of which are hereby incorporated herein by reference.

### FIELD

At least one embodiment of the present invention generally relates to a method for controlling the temperature of a building equipped with at least one cooling/heating system through which a liquid flows and which is integrated into the ceiling of a building floor, wherein a desired or target value for a flow temperature of the liquid is generated in dependence on the ambient air temperature (Ta) for the building. At least one embodiment of the invention furthermore generally relates to a device.

In the following, a floor ceiling with an integrated cooling/heating system of this type is also referred to as a thermo-active ceiling or TAD.

### BACKGROUND

Thermoactive ceilings or TADs have been used for a number of years to reduce energy consumption and to increase the comfort level.

The following problems, however, have been encountered because of the high thermal inertia of the TAD, resulting from the large mass of the ceiling in connection with its specific heating capacity. The high thermal inertia slows down the capacity adjustment to the outer and inner heating sources and heat sinks of the building. Tests have shown, for example, that a sudden jump in the ambient air temperature results only after several hours in a noticeable change in the temperature detected within the thermo-active ceiling. Conversely, it takes several hours until a change in the flow temperature, meaning a change in the temperature of the liquid cooling/heating medium prior to entering the TAD, affects a change in the room temperature.

Additional heating units and/or recirculating cooling units are thus used per se in known buildings equipped with TAD to permit comparatively fast interventions for controlling the temperature.

It can happen in that case that the TAD and the additional heating units and/or recirculation cooling units influence the room temperature in opposite directions. This counter-heating or counter-cooling is connected to an extremely high energy consumption. To reduce the problem of counter-heating and counter-cooling problem to a minimum, the TADs used in known buildings are not actively operated at ambient air temperatures ranging from 0° C. to +18° C., meaning it is shut down. The theoretical advantages of the TAD with respect to energy consumption therefore remain unused for temperatures in this temperature range which exist in some areas of Central Europe and in comparable regions for approximately 75% of the year.

### SUMMARY

At least one embodiment of the present invention provides a method and/or a device which allows operating a TAD during a larger share of a year for the heating and/or cooling of the building, without resulting in counter-heating or counter-cooling, thus permitting a more economic operation of the building heating and/or cooling system. In the ideal case, additional heating units and/or recirculating cooling units could be omitted.

With respect to the method aspects, at least one embodiment of the present invention is distinguished in that the desired value for the flow temperature is generated by using a predicted fictional ambient air temperature for a future point in time, wherein a basic value for the predicted ambient air temperature is determined as a function value of a function which maps points in time located within a single day to predetermined temperature values, wherein a radiation temperature of the sky above the building is measured and a degree of clouding is determined in dependence on the measured radiation temperature, wherein a correction value is formed in dependence on the determined degree of clouding, wherein the basic value is linked with the correction value and the fictional ambient air temperature predicted for the future point in time is then formed as a function of the linking.

The ambient air temperature for a future point in time critically influences the heating capacity and/or cooling capacity of a TAD which is required for said point in time. With knowledge of the future ambient air temperature, the flow temperature of the TAD can be controlled early enough so that the heating capacity or the cooling capacity provided by the TAD coincides better than in the past with the actual capacity required at the future point in time, taking into consideration the thermal inertia.

Owing to the fact that a function value which maps points in time within a single day to specified temperature values is determined as basic value, the general development and fluctuation of the daily temperature which depends on the time of day can be taken into consideration.

The amplitude for this fluctuation depends on the heat exchange between the building and the surrounding area and thus on the heat transport through the atmosphere, which itself strongly depends on the cloud cover. The comparably large amplitude with a clear sky decreases with an increase in the cloud cover. Owing to the fact that according to at least one embodiment of the invention a degree of clouding is determined, that a correction value is formed in dependence on the determined degree of clouding, that the basic value is linked with the correction value and that the first temperature value, which is predicted for the future point in time, is formed as a function of the linking of the basic value with the correction value, the invention makes it possible to take into consideration the influence of the heat transport through the atmosphere on the ambient air temperature that will adjust at the future point in time. It has furthermore turned out that the degree of clouding can be expressed easily as a function of a measured radiation temperature of the sky.

On the whole, at least one embodiment of the invention allows extending the partial periods of a year in which the TAD is used exclusively for the heating and cooling operation. In the ideal case, additional heating surfaces can be omitted.

Further advantages of at least one embodiment of the invention include that the flow temperature can be reduced, wherein an upper limit temperature of max. 30° C. is desired. At least one embodiment of the invention is thus suitable for use with heating systems using low heating-water temperatures, such as are provided by heat pumps and solar collectors with high utilization ratios.

The same is also true for the cooling operation, which can occur at higher flow temperatures. A cooling with a lower limit for the flow temperature of approx. 16° C. is suitable especially for the natural cooling with adiabatic back cooling systems and/or with ground collectors and/or with energy piles or with ground water. At least one embodiment of the invention thus permits the heating and/or cooling of a building in accordance with the comfort criteria formulated in the DIN EN 15251 Standard, which are achieved exclusively by using a TAD.

It is furthermore advantageous that as a result of the extremely low temperature differences between the flow temperature and the main ceiling temperature, heat is displaced by the TAD and the cooling/heating liquid from warmer rooms to cooler rooms, thereby resulting in a noticeable reduction in the heating/cooling load. Depending on the orientation of the building with respect to the cardinal direction, an energy saving of 20% to 30% can thus be achieved. This effect, which can be increased further through crossing of the return lines (for buildings which are clearly oriented according to the cardinal directions), has been verified through measurements and calculations with the aid of simulation.

Furthermore advantageous is that the function is used to project a respectively predetermined position for a temperature minimum and a temperature maximum within a single day, as well as a predetermined value for a temperature fluctuation within that same day.

This type of embodiment allows taking into consideration the normal course for the daily temperature which has a minimum value early in the morning and reaches a maximum value late in the afternoon. This fluctuation can be approximated, for example with a sine function or a sum of a sine function, wherein the length of the period is 24 hours.

A different, example embodiment is distinguished by a multiplicative linking of the correction value with the basic value.

Whereas the points in time for the temperature minimum and the temperature maximum depend little or not at all on the clouding, the clouding strongly influences the minimum and maximum temperature values and thus also the amplitude of the temperature fluctuation. In addition, the amplitude is also influenced by the mean temperature for the day, wherein the amplitude is smaller for low mean values than for high mean values.

With an increase in the clouding, the amplitude decreases while it increases with a decrease in the clouding. The multiplicative linking expands or compresses the modeled temperature difference in such a way that it is adapted well to the actual influence of the cloud cover. This is particularly true for an embodiment where the degree of clouding is determined to assume values between zero and a maximum value, wherein the zero value characterizes a clear sky and the maximum value (1.0) characterizes a maximum clouding of the sky.

It is furthermore advantageous if a first value for the radiation temperature of the sky is measured, if a second value for the radiation temperature of the sky is computed for a clear sky, if an ambient air temperature of the building is measured, and if the degree of clouding is determined in dependence on the first value for the radiation temperature, the second value for the radiation temperature and the measured ambient air temperature. A further embodiment provides for determining the second value of the radiation temperature in dependence on a computed dew point temperature.

It has turned out that determining the degree of clouding in dependence on these variables allows a suitable mapping of the influence of the clouding to the ambient air temperature to be predicted.

A further example embodiment is distinguished in that the degree of clouding is determined as a quotient of temperature differences, wherein a difference between the first value for the radiation temperature and the second value for the radiation temperature is standardized to a difference between the ambient air temperature and the second radiation temperature.

This type of calculation supplies the desired behavior of the modeled degree of clouding as numerical value that varies between zero and a maximum value. In this connection, we want to point out that the term degree of clouding, as understood for this application, characterizes the heat transport through the atmosphere and need not coincide with the meteorological term of the degree of clouding.

It is furthermore advantageous that an actual value for the humidity in the ambient air is measured and that the second radiation temperature value, which is computed for the clear sky, is computed in dependence on the actual ambient air temperature and the actual value for the humidity in the ambient air.

This type of embodiment permits taking into account the influence of the humidity in the ambient air surrounding the building on the heat transport through the atmosphere.

It is further advantageous that a first value for the degree of clouding is determined and stored for the actual point in time, that a second value is determined and stored for the degree of clouding at a point in time during the previous day which corresponds to the actual point in time, that a difference is formed between the first value for the degree of clouding and the second value for the degree of clouding and that the correction value is formed in dependence on this difference, wherein the correction value in particular is formed as proportional to the difference or as a value that is identical to the difference.

Owing to this type of embodiment, the correction value only changes if the cloud cover changes. In connection with the embodiment, based on which the degree of clouding varies between the value zero for a clear sky and the maximum value for a completely covered sky, the effect obtained is that the difference and thus the correction value is positive for a decreasing cloud cover and is negative for an increasing cloud cover. As a result, the amplitude is expanded for a decreasing cloud cover and is compressed for an increasing cloud cover.

It is furthermore advantageous that the result obtained by linking the basic value for the ambient air temperature for the future point in time and the correction value, formed in dependence on the determined degree of clouding, is additionally guided by the temperature course for the previous day.

The predicted value therefore is so-to-speak determined as a change in the value from the previous day, which ensures a reconciliation between the prediction and the reality.

It is particularly advantageous that for the control using the temperature course of the previous day, the temperature is determined at a point in time on the previous day which corresponds to the future point in time during the actual day and is added to the result obtained through the linking.

Insofar, the result of the linking represents the predicted change, relative to the previous day, so that the predicted value is determined as the sum of a value measured in the past, which is precisely known, and a predicted change. Insecurities in the prediction therefore affect only the value of the change, so that on the whole a good accuracy of the predicted total value is obtained.

It is furthermore advantageous that a first temperature value is measured at the actual point in time, that a second temperature value is measured at a point in time on the previous day which corresponds to the actual point in time, that a difference is determined from the first value and the second value and that this difference is then added to the result of the linking.

The difference corresponds to the measured temperature difference between the two days. It is to be expected that the temperature difference, determined for the actual point in time from the measured temperature values, represents a good approximation for a difference value which can be used for all points in time of the day.

This type of embodiment ensures that the trend for a temperature change is determined and is taken into account for the prediction. Owing to the fact that the difference is formed from values determined for the same points in time of a day, the trend detected in this way is not negatively influenced by periodic fluctuations of the ambient air temperature during a period of 24 hours.

The same advantages are respectively obtained in connection with the device aspects of embodiments of the invention.

Additional advantages follow from the dependent claims, the specification and the enclosed Figures.

It is understood that the aforementioned features and those still to be discussed in the following can be used not only in the respectively stated combination, but also in other combinations or by themselves, without leaving the framework of the present invention.

### BRIEF DESCRIPTION OF THE DRAWINGS

Example embodiments of the invention are illustrated in the drawings and will be explained further in the following description, respectively showing in a schematic form in:

FIG. 1 illustrates a technical field for the invention; and

FIG. 2 illustrates a TAD together with a device for controlling the TAD flow temperature.

### DETAILED DESCRIPTION OF THE EXAMPLE EMBODIMENTS

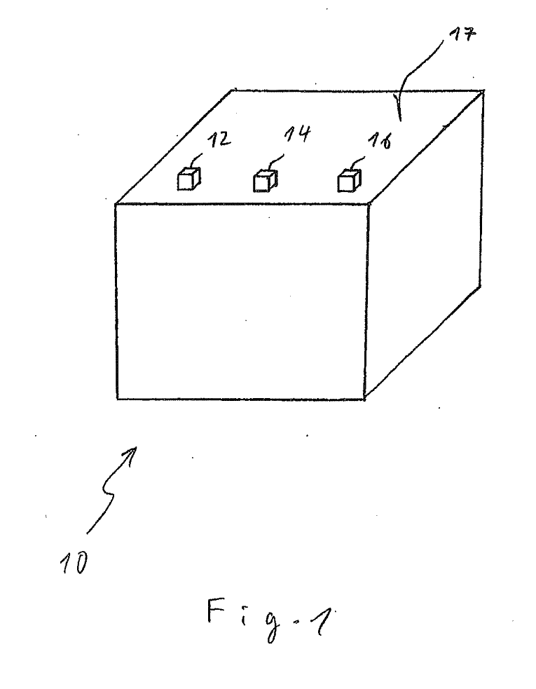

FIG. 1 shows in further detail a building 10 equipped with at least one TAD. A sensor 12, in particular, is assigned to the building 10 for detecting the heat irradiation from the sky. The sensor 12 is preferably an infrared sensor, the signal of which represents a measure for the temperature of the atmosphere. A measure for this temperature is henceforth also referred to as irradiation temperature of the sky or as sky temperature. Infrared sensors of this type are known per se, for example in the form of infrared pyrometers. Preferably used for the measurement is an infrared pyrometer having a measuring range of −50° C. to +200° C. which is oriented with an angle of inclination of approximately 45°, relative to the horizontal line and in a western direction.

Example embodiments of the invention use an ambient air temperature sensor 14 and/or a humidity sensor 16 in addition to the infrared sensor 12. The sensors 12, 14 and 16 with the design as shown in FIG. 1 are installed on the building 10 roof These sensors are protected against direct sun irradiation by protective devices, which are not shown in further detail herein. The sensors 12, 14 and 16 can also be arranged spatially separate from the building 10, wherein it is only essential that the signals reflect the values locally valid for the irradiation temperature, the ambient air temperature and the humidity for the building 10 location.

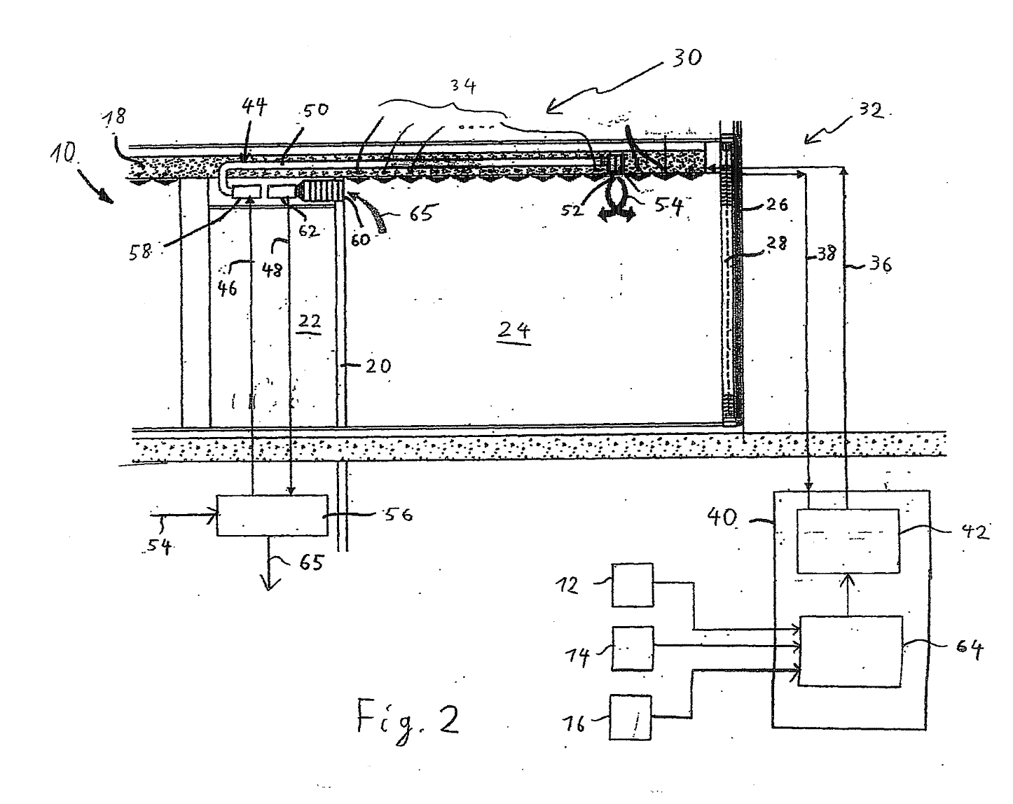

FIG. 2 shows additional details of the technical aspects of an example embodiment of the invention in the form of a schematic sectional view of a partially represented floor in an optional building per se, which is provided with a preferred TAD.

FIG. 2 shows in further detail a sectional view of a portion of a concrete ceiling 18 for a floor of the building 10. A wall 20 is indicated between a hallway or a central area 22, optional per se, and an inside room 24 of the building where the temperature is to be controlled. Furthermore shown is a wall of windows 26 with schematically indicated shading device 28.

A water-based heating/cooling system 30 which is integrated into the concrete ceilings 18 is provided for controlling the temperature of the building 10, meaning for the heating and cooling of the building. This water-based heating/cooling system 30 comprises a system of water-conducting lines 32 with heating/cooling pipes 34 which are respectively integrated, meaning embedded, into the concrete ceiling 18. The system of water-conducting pipes 32 comprises a forward-flow 36 portion and a return flow portion 38. For the example embodiment shown herein, the heating/cooling pipes 34 are installed at a distance of approximately 60 to 80 mm to the respective surface of the concrete ceiling 18 which is facing the inside room 24. They are arranged, for example, at a distance of 20 to 30 cm relative to each other. The water-based heating/cooling system 30 is preferably operated continuously, even during the night. Water at a correspondingly controlled temperature flows at the relatively low flow speed of preferably 0.1 to 0.7 m/s through the heating/cooling pipes 34 in the region where these are embedded into the concrete. The temperature control of the building 2 can thus be realized advantageously and exclusively with the water-based heating/cooling system at all times of the year.

A central unit, indicated with reference 40, for the cooling/heating system is preferably provided at a central location of the building 2. In this unit, the water flowing back through the return portion 38 of the system of water-conducting pipes 32 is again heated up to the ambient conditions, especially the outside temperature, or to the flow temperature that depends on additional parameters, so that it can again be conducted into the forward flow portion 36 of the circulatory system.

The water-based heating/cooling system 30 is always operated as a low-temperature system, meaning it is operated for all typically occurring outside temperatures, for example ranging from −30° C. to +35° C., at a flow temperature of the water that preferably ranges from 15° C. to 40° C., in particular ranging from 17° C. to 33° C. Since the return-flow temperature of the water leaving the concrete ceiling and flowing back to the cooling/heating central unit 40 for a preferred realization of the method differs advantageously by no more than 5° C. from the flow temperature that must be adjusted once more, no conventional heating units or cooling units are required for controlling the water temperature of the water-based cooling/heating system 30.

The option of using heat exchanging devices 42 has proven advantageous in this case, wherein these devices utilize so-called natural energies for the heat-exchanging medium. For example, a ground collector having extremely long lines can be installed below the building, by means of which heat is removed during the cooling operation of the building from the water flowing back through the return flow line 38, or heat can be released during the heating operation to the water flowing back through the return-flow line 38.

So-called energy piles can also be used for which, in contrast to the typical ground collectors, the medium is conducted in vertical pipes embedded in concrete piles. It has proven particularly advantageous for the cooling operation if an adiabatic re-cooling system is used which, preferably, operates with outside air taken from the area surrounding the building. This outside air is subjected to an atomizing device that sprays a water mist, so that it is cooled as a result of the evaporation of the water mist and can then be used for the heat exchange with the return-flow water. If that should not be sufficient, the aforementioned ground collector or energy pile can be used in addition or instead. Irregardless, heat pumps can also be used which are known per se or, as well as conventional cooling/heating units. Of course, long-distance heat can also be used for the heating operation in the heat-exchanger 42.

For the ventilation, meaning for the fresh-air supply to the building 10, one example embodiment provides for a separate pipe system 44 with a fresh air supply section 46 and an exhaust air discharge section 48, wherein this pipe system is uncoupled from the water-conducting heating/cooling system 30. The air supply portion 46 of the pipe system 44 for supplying fresh air comprises a plurality of pipe sections 50 that are at least 4 m long and are assigned to the respective inside room 24, wherein these sections are embedded into the concrete ceiling 18 of each inside room 24 and empty via a respective flow opening 52 into the respective inside room 24.

The fresh air to be supplied to the building 10 and its inside rooms 24 preferably is 100% fresh outside air, meaning it is not mixed air. The fresh air to be supplied is suctioned in from the area surrounding the building 10 (reference 54) and is then supplied to the heat-exchanger unit 56, for example provided at a central location in the building 10, in which a thermal coupling occurs with the exhaust air flowing out through the exhaust-air section 48 of the pipe system 44, thus also resulting in a pre-control of the temperature of the fresh air to be supplied to the inside rooms 24, wherein the heat-exchanger unit 56, for example, can be a plate-type heat exchanger.

The fresh air supplied from the outside, for which the temperature is controlled in the heat exchanger unit 56, is supplied via the air portion 46 of the pipe system 44, typically via inside vertical risers, to the individual floors where, in particular, a horizontal supply air duct 58 can be provided for each floor in a suspended ceiling section. Extending outward from this horizontal supply air duct 58 are the previously mentioned sections 50 which are embedded into the concrete ceiling 18 and empty via a respective inflow opening 52 into the respective inside room 24. As can furthermore be seen, an outflow opening 60 for the exhaust air is provided in the respective inside room 24 which leads via a relatively short section to a horizontal exhaust-air duct 62 which runs parallel to the horizontal fresh-air duct for the exemplary embodiment.

It has turned out that even when using very simple and smooth plastic pipes which are commercially available for the concrete embedded sections 50, with a section length of only at least 4 m, it is possible to control the temperature of the fresh air to be supplied to the inside rooms 24 to essentially match the temperature of the water-cooled and/or water-heated concrete ceiling 18, so that the fresh air flowing into the inside rooms 24 is not felt to be uncomfortably cold or warm.

The fresh air conducted through the concrete-embedded sections 50 into the respective inside space is thus heated or cooled to the temperature of the water-temperature controlled concrete ceiling 18. The temperature of this air typically has values between the temperature of the water conducted in the ceiling and the ceiling radiation temperature, depending on where and how the air-conducting sections 50 of the fresh-air conducting portion 46 of the pipe system 44 are installed in the concrete ceiling 18 with respect to the water-conducting cooling/heating pipes 34 of the water-based cooling/heating system 30. The exhaust air flowing out of the inside rooms 24 flows out at the typical room temperature for the inside rooms 24 and via the part 48 that carries the exhaust air to the heat exchanger unit 56 and is then vented to the area surrounding the building (reference 65).

FIG. 2 in particular shows the ceiling 18 of a building 10 floor with integrated heating/cooling system 30. The ceiling 18 represents an embodiment of a TAD and is also referred to as TAD 18 in the following. For the embodiment shown herein, the integrated cooling/heating system 30 in particular is realized with the cooling/heating pipes 34 installed in the material for the ceiling 18 and is thus thermally coupled with the material of this ceiling 18. The cooling/heating pipes 34 are connected via the forward-flow 36 and the return-flow 38 to a cooling/heating adjustment device 42. The cooling/heating adjustment device 42 advantageously consists of an arrangement of at least one controllable heat source and/or heat sink, for example the aforementioned heat exchanger 42 in connection with controllable valves and/or pumps, as well as heat reservoirs having different temperatures.

The influence of the cooling/heating adjustment device 42 on the flow temperature is controlled with the aid of a control device 64. The cooling/heating liquid circulating in this hydraulic circulation either supplies heat to the TAD 18 or it absorbs the heat from the TAD. The direction of the heat transport and the amount of transported heat is essentially determined by the flow temperature Tv of the cooling/heating liquid as it enters the cooling/heating pipes 34 of the TAD 18.

To adjust the flow temperature Tv, the control unit 64 initially generates a desired value Tv_desired, using various input variables, for the flow temperature Tv. For the embodiment shown herein, these input variables are the signals from the previously mentioned sensors 12, 14 and 16, meaning the variables for a radiation temperature of the sky above the building 10, an ambient air temperature and the humidity of the ambient air. To adjust the flow temperature Tv to the desired value Tv_desired, the control unit 64 forms adjustment variables SG_42 for activating the cooling/heating adjustment device 42. Additional signals from additional sensors can also be used, wherein these are not shown explicitly in FIG. 2. Examples of such sensors are the inside room temperature sensors for the building 10 and/or a flow temperature sensor, the signal of which can close a control circuit for adjusting the flow temperature.

The control unit 64 is configured, in particular programmed, to realize a method having the features as disclosed in claim 1 and/or the features of the subordinate method claims, wherein the degree of clouding is formed in dependence on the signal from the radiation sensor 12, if applicable supplemented by the signal from the ambient air temperature sensor 14. The control unit 64 together with the sensor 12 and, if applicable, supplemented by the sensor 14, therefore represents one exemplary embodiment of an inventive device. According to one example embodiment, the control unit 64 is furthermore programmed to adapt parameters of the equations used to the actual conditions by employing a teaching program.

According to one example embodiment, the ambient air temperature Tfa(x) is predicted for a point in time located x hours into the future, based on the following equation:

Tfa(x)=Ta(−24+x)+Ta(0)−(−24)+sine[(b+hour of the day)·C1]·(C(−24)−C(0))·α

The factor C1 maps the 24 hours of a day to a period of the sine function, meaning to the interval ranging from 0 to 2πor from 0 to 360°. For the use of the angle interval from 0 to 2πwhich is expressed as radian measure, C1=π/12; for the use of the angle interval 0 to 360° which is expressed in degrees, the factor C1=15.

The function value of the sine function forms a basic value for the ambient air temperature to be predicted Tfa(x). The sine function maps points in time of a single day, referred to as hours of the day for the argument of the sine function, to predetermined temperature values. The values are initially located in the interval between −1 and 1 and are predicted by the amplification factor a, if applicable, to a temperature interval with different limits. The period length is 24 hours. The parameter b displaces the sine curve relative to the time of day, so that the minimum for the sine curve is at the minimum temperature early in the morning and so that the maximum for the sine curve is at the temperature late in the afternoon.

This basic value foamed with the sine function is linked to a correction value C(−24)−C(0) which is formed in dependence on a determined degree of clouding C.

In addition, the result of the linking is additionally guided by the temperature course of the preceding day. For this guidance, the temperature Ta (−24+x) is determined for a point in time of the previous day which corresponds to the future point in time on the actual day and is added to the result of the linking. A first value Ta(0) of the temperature is furthermore measured at the actual point in time, a second value T(−24) is determined for the temperature at a point in time of the previous day that corresponds to the actual point in time, a difference T(a)−T(−24) is determined from the first value Ta(0) and the second value Ta(−24), and the difference is then added to the result of the linking.

According to one embodiment, the degree of clouding C is determined as follows: A first value T_sky(tat) is measured for the sky temperature, meaning the radiation temperature of the sky, and/or is determined from signals of the radiation sensor 12. In addition, a second value T_sky (min) of the radiation temperature of the sky is computed for a clear sky.

The temperature Tsky_min is computed for a clear sky with the aid of an empirical equation, e.g. the following equation:

Tsky_min=(0.736+0.00571Tdp+0.000003318(Tdp)2)0.25(Tdp+273.15)−273.15

wherein Tdp is the dew point temperature which is computed from the air temperature and the relative humidity of the air. Both values are measured.

Empirical formulas are also known as alternatives which take into account the additional influences of the humidity in the ambient air. In this connection, we point out as example the publication “Measurement of night sky emissivity in determining radiant cooling from cool roofs and roof ponds” published by the University of Nebraska. According to this publication, the temperature for a clear sky is computed based on the outside temperature, which in this case is the ambient air temperature detected by the sensor 14, and the humidity of the outside air which can be detected with the humidity sensor 16. With this type of embodiment, an actual value of the humidity in the ambient air is measured and the second value for the radiation temperature, computed for the clear sky, is computed in dependence on the actual ambient air temperature and the actual humidity computed for the ambient air.

The measured ambient air temperature is furthermore used separately for forming the degree of clouding, so that the degree of clouding is on the whole determined in dependence on the first value of the radiation temperature, the second value of the radiation temperature and the measured ambient air temperature.

The degree of clouding is preferably determined as a quotient of temperature differences, wherein a difference between the first value for the radiation temperature value and the second value for the radiation temperature is standardized to a difference between the ambient air temperature and the second radiation temperature:

$$C = \frac{T\_sky ( tat ) - T\_sky ( min )}{Ta ( 0 ) - T\_sky ( min )}$$

Thus, if the counter is equal to zero then C=0 which is the case for a clear sky. With a completely covered sky, on the other hand, the counter differs from zero and the measured sky temperature Tsky is approximately equal to the measured ambient air temperature. In that case, the quotient is equal to 1.

A first value C(0) of the degree of clouding C is determined and stored for the actual point in time. Furthermore determined, meaning read out, is a second value C(−24) for the degree of clouding C which was stored for a point in time on the previous day that corresponds to the actual point in time. The difference C(0)−C(−24) is then formed based on the first value C(0) for the degree of clouding and the second value C(−24). The aforementioned difference is subsequently also multiplied with a specifiable amplification factor a and the resulting product represents the correction value, formed in dependence on the difference between the aforementioned degrees of clouding.

The correction with the aid of the difference C(0)−C(−24) consequently has the following effect: If the clouding does not change as compared to the previous day, the correction value is zero and the product of the correction value and the basic value is also zero. The aforementioned rule for computing the future ambient air temperature is then reduced to:

Tfa(x)=Ta(−24+x)+Ta(0)−Ta(−24)

This equation only contains measured values for the ambient air temperature which have already been detected and stored and which function to guide the result of the linking of the basic value for the ambient air temperature, predicted for the future point in time, and the correction value which is determined in dependence on the degree of clouding by using the temperature course of the preceding day. The temperature T(−24+x) represents the temperature of the previous day as approximation value for the temperature to be predicted for the future point in time x of the current day while the difference T(0)−T(−24) represents the trend in the temperature change between the previous day and the current day. If we consider the values of this sum over the course of a whole day, then the course of these values will have a minimum for current points in time which are in the early morning hours and a maximum for current points in time which are in the late afternoon hours.

However, if the clouding increases, then C(0) becomes greater than C(−24) and the difference C(−24)−C(0) will assume a negative value that differs from zero. The product resulting from the sine function and the difference is then also unequal to zero and is negative. It means that the approximation value based on the measured values Ta(−24), Ta(0) and Ta(−24) is modeled by the sine function. Owing to the fact that the linking value is negative, however, the mathematical sign of the sine function changes, which corresponds to a phase displacement by 180° as compared to the fluctuation course for the sum of the first three temperatures Ta(−24+x), Ta(0) and Ta(−24). The influence of the sine function in that case has the effect that the predicted fictional ambient air temperature is higher, relative to the sum of the first three temperatures, for points in time during the night and is lower for points in time during the day.

A decrease in the clouding has the reverse effect, so that the computing rule is good for mapping the actual influence of the clouding to the ambient air temperature that adjusts later on.

According to one embodiment, the value Tv_desired for the flow temperature Tv is determined in dependence on the ambient air temperature Tfa(x), predicted as function of the degree of clouding:

Tv_desired=max(18;d-e·Tfa(x))

In other words, selecting a maximum value is intended to restrict Tv_desired to a lower value, in this case 18° C., as the minimum flow temperature, thereby preventing an undesirable condensation of moisture. The predeterminable parameters d and e can be adapted to the building and can have values, for example, of d=24, 25° C. and e=0.25. For a predicted ambient air temperature of 5° C., a desired value of Tv_desired of (max(18; 24,25−0.25*5)=23° C. is thus obtained.

In other words, the embodiment of the invention that is realized with the following formula:

Tfa(x)=Ta(−24+x)+Ta(0)−Ta(−24)+sine[(b+hour of day)·(C1]·(C(−24)−C(0))·α

can also be described as follows:

The temperature Ta(−24+x) known from the previous day represents an approximation of the ambient air temperature to be expected during the course of the current day for a later point in time x. T(0) is the actually measured temperature and the temperature Ta(−24) is the temperature measured 24 hours earlier. The difference Ta(0)−Ta(−24) thus provides a value for the temperature change between the day before and the present day and is used as approximation value for the corresponding temperature difference between the future point in time x and the ambient air temperature existing at the point in time x 24 hours earlier and is added to the temperature T(−24+x).

The sine function delivers a basic value for a temperature fluctuation that depends on the hour of the day (time of day). This value is between −1 and +1 and is multiplied with a correction function (C(−24)−C(0)) that maps the change in the degree of clouding above the building. The factor “a” is an amplification factor which serves as adjustment parameter for adapting the control to the conditions existing for a real building. While the points in time for the temperature minimums and the temperature maximums do not depend or only to a small degree on the clouding, the degree of clouding strongly influences the minimum and maximum values of the temperature and thus also the amplitude of the temperature fluctuation. In addition, the amplitude is also influenced by the mean temperature. With low mean values, the amplitude is smaller than with high mean values. According to one embodiment, these influences are also predicted onto the factor C and are taken into consideration this way.

In this sense, an embodiment of the invention can also be defined as follows: An embodiment of the invention relates to a method for controlling the temperature of a building 10, provided with at least one cooling/heating system 30 through which a liquid flows and which is integrated into the ceiling 18 of a building 10 floor, wherein an ambient air temperature for the building 10 is measured and a desired value for a flow temperature of the liquid is formed in dependence on the measured ambient air temperature and a value for the degree of clouding of the sky above the building. A fictional ambient air temperature predicted for a future point in time is used to form a desired value for the flow temperature.

The method of at least one embodiment is distinguished in that an ambient air temperature, measured on the previous day at a point in time which corresponds to the future point in time for which the ambient air temperature is to be predicted, is added to a difference between an ambient air temperature, measured at the current point in time and an ambient air temperature measured 24 hours earlier, and that a product, formed with a sine function and a correction function which depends on the change in the clouding above the building, is added to the aforementioned sum, wherein the sine function supplies a basic value for a temperature fluctuation depending on the time of day and wherein the correction function projects a change over the last 24 hours in the degree of clouding above the building.

The degree of clouding is thus preferably determined in the manner as explained in the above, with reference to the equation. The device aspects of an embodiment of the invention can be defined analogous thereto in that the device 12, 64 is designed for realizing such a method.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method for controlling the temperature of a building, equipped with at least one cooling/heating system with a liquid flowing through it, the system being integrated into a ceiling of a building floor, the method being usable to measure ambient air temperature of the building and form a desired value for the flow temperature of the liquid in dependence on the measured ambient air temperature, the method comprising:
using, in order to form the desired value for the flow temperature, a fictional ambient air temperature is used that is predicted for a future point in time;
determining a basic value for the predicted ambient air temperature is as a function value of a function which maps points in time located within a single day to temperature values;
measuring a radiation temperature of the sky above the building;
determining a degree of clouding in dependence on the measured radiation temperature;
forming a correction value in dependence on the ascertained degree of clouding;
linking the basic value to the correction value; and
forming the fictional ambient air temperature predicted for the future point in time, as a function of the linking.

2. The method according to claim 1, wherein the function maps a respectively position for a temperature minimum and a temperature maximum in a single day, and a value for a temperature fluctuation within one day.

3. The method according to claim 2, wherein the correction value is linked multiplicative with the basic value.

4. The method according to claim 1, wherein the degree of clouding is determined such that it can assume values between the value zero and a maximum value, wherein the value zero characterizes a clear sky and the maximum value characterizes a maximum cloud cover for the sky.

5. The method according to claim 4, wherein a first value for the radiation temperature of the sky is measured, a second value for the radiation temperature of the sky is computed for a clear sky, an ambient air temperature of the building is measured and the degree of clouding is determined in dependence on the first value of the radiation temperature, the second value for the radiation temperature and the measured ambient air temperature.

6. The method according to claim 5, wherein the degree of clouding is determined as a quotient of temperature differences, wherein a difference between the first value for the radiation temperature and the second value for the radiation temperature is standardized to a difference between the ambient air temperature and the second radiation temperature.

7. The method according to claim 5, wherein an actual value is measured for the humidity in the ambient air and the second radiation temperature value for the clear sky is then computed in dependence on the actual ambient air temperature and the actual value for the humidity of the ambient air.

8. The method according to claim 1, wherein a first value for the degree of clouding is determined and stored for the actual point in time, a second value for the degree of clouding is determined at a point in time on the previous day that corresponds to the actual point in time, a difference between the first value for the degree of clouding and the second value for the degree of clouding is then formed and the correction value is subsequently formed in dependence on this difference.

9. The method according to claim 1, wherein the result obtained by linking the basic value for the ambient air temperature for the future point in time and the correction value, formed in dependence on the determined degree of clouding, is additionally controlled by the temperature course of the preceding day.

10. The method according to claim 9, wherein, for the guidance based on the temperature course of the previous day, the temperature is determined at a point in time of the previous day which corresponds to the future point in time in the current day and wherein the result is added to the result obtained by linking.

11. The method according to claim 9, wherein a first temperature value is measured for the current point in time, a second temperature value is measured for a point in time on the previous day which corresponds to the current point in time, a difference is determined between the first value and the second value, and the difference is added to the result of the linking.

12. A device for controlling the temperature of a building that is provided with at least one cooling/heating system through which a liquid flows and which is integrated into the ceiling of the building floor, said device being configured to measure an ambient air temperature of the building and for forming a desired value for the flow temperature of the liquid in dependence on the measured ambient air temperature, the device being configured, to obtain the desired value for the flow temperature, to:
use a fictional ambient air temperature predicted for a future point in time,
determine a basic value for the predicted ambient air temperature as a function value of a function which maps points in time located in a single day to temperature values,
measure a radiation temperature of the sky above the building,
determine a degree of clouding is determined in dependence on the measured radiation temperature,
form a correction value in dependence on the determined degree of clouding,
link the basic value with this correction value,. and
form the fictional ambient air temperature, predicted for the future point in time, as a function of the linking.

13. (canceled)

14. The method according to claim 6, wherein an actual value is measured for the humidity in the ambient air and the second radiation temperature value for the clear sky is then computed in dependence on the actual ambient air temperature and the actual value for the humidity of the ambient air.

15. The method according to claim 10, wherein a first temperature value is measured for the current point in time, a second temperature value is measured for a point in time on the previous day which corresponds to the current point in time, a difference is determined between the first value and the second value, and the difference is added to the result of the linking.

16. A tangible computer readable medium including program segments for, when executed on a computer device, causing the computer device to implement the method of claim 1.

17. A device for controlling the temperature of a building that is provided with at least one cooling/heating system through which a liquid flows and which is integrated into the ceiling of the building floor, said device being configured to measure an ambient air temperature of the building and for forming a desired value for the flow temperature of the liquid in dependence on the measured ambient air temperature, the device being programmed, to obtain the desired value for the flow temperature, to:
use a fictional ambient air temperature predicted for a future point in time,
determine a basic value for the predicted ambient air temperature as a function value of a function which maps points in time located in a single day to temperature values,
measure a radiation temperature of the sky above the building,
determine a degree of clouding is determined in dependence on the measured radiation temperature,
form a correction value in dependence on the determined degree of clouding,
link the basic value with this correction value, and
form the fictional ambient air temperature, predicted for the future point in time, as a function of the linking.
